(19) United States
(12) Patent Application Publication
(10) Pub. No.: US 2012/0008162 A1
(43) Pub. Date: Jan. 12, 2012

(54) Image information input system, image information input apparatus and image information input method

(75) Inventor: Naoki Takishima, Kanagawa (JP)

(73) Assignee: Ricoh Company, Ltd., Tokyo (JP)

(21) Appl. No.: 13/067,454

(22) Filed: Jun. 2, 2011

(30) Foreign Application Priority Data
Jul. 7, 2010 (JP) 2010-154992
Dec. 22, 2010 (JP) 2010-286145

(51) Int. Cl. G06F 15/00

(52) U.S. Cl. 358/1.15

(57) ABSTRACT

An image information input system inputs image information into another system that handles the image information. The image information input system obtains plural items of image information generated as a result of plural sheets of paper of an original document being read, obtains original identification information to be used for identifying each sheet of paper of the original document, for each of the plural items of image information, associates the plural items of image information and the original identifying information obtained for each of the plural items of image information, outputs it, and stores the output plural items of image information and the output original identification information associated with the plural items of image information. When each of the plural items of the image information is obtained, a number to be used to identify each sheet of paper of the original document is obtained as the original identification information.

### BACKGROUND OF THE INVENTION

1. Field of the Invention

The present invention relates to an image information input system, an image information input apparatus and an image information input method. In particular, the present invention relates to an improvement in a function of linking one system with another system when image information to be handled by the other system is input into the other system from the one system.

2. Description of the Related Art

A recent trend is to promote computerization of information, and thus, image processing apparatuses such as a printer and a facsimile machine to be used for outputting computerized information, a scanner that is used for computerizing a document, and so forth, may become indispensable apparatuses. In some cases, an image processing apparatus may be configured as a multifunction peripheral that has an image reading function, an image forming function, a communication function, and so forth, and thus is usable as a printer, a facsimile machine, a scanner and a copier.

A method has been proposed, and according to the method, images are generated by a scanner to be used for computerizing an original document that includes double and single sided pages, and the generated images only include those that have been read from such sides of the pages of the original document that images are actually formed (for example, see Japanese Laid-Open Patent Application No. 2002-229391 (Patent Document 1)). It is noted that the double-sided pages of the original document are those each of which page has images formed on both sides, and the single-sided pages of the original document are those each of which page only has an image formed on one side.

Recently, concerning a scanning process of scanning an original document for business purposes, such a system may be used that a workflow is previously set in which plural processes are combined such as a scanning process, a process of adding information, a process of delivering information via a communication network, a process of storing information, and so forth. In such a system, an image generated from a scanning process may be processed according to the workflow. For example, a system may be established such that a central office of a company, branch offices, sales branches, and so forth, are connected via a communication network, whereby a contract document, an application form, or such, created by a branch office or a sales office is scanned, and the scanned document is automatically registered in a server of the central office.

In a case where such a system is provided, it is expected that various processes are automated wherever possible, and also, the provided system is linked with a business system of a company to which the provided system is supplied. From such a point of view that various processes are automated wherever possible, it is preferable to deliver and store plural documents, having been computerized at the same time, into a storage unit such as a server. However, in this case, a user is to determine, by visual inspection, which image of thus-obtained images corresponds to which page of which document of the plural documents.

According to Patent Document 1, processes may be automated, but it may not be easy to determine which image of obtained images corresponds to which page of which document of plural documents.

### SUMMARY OF THE INVENTION

According to an embodiment of the present invention, an image information input system inputs image information into another system that handles the image information. The image information input system includes an image information obtaining part that obtains plural items of image information that is generated as a result of plural sheets of paper of an original document being read and an original identification information obtaining part that obtains original identification information to be used for identifying each sheet of paper of the original document, for each of the obtained plural items of image information. The image information input system also includes an information output part that associates the obtained plural items of image information and the original identifying information obtained for each of the plural items of image information, and outputs it. The image information input system further includes an information storage part that stores the output plural items of image information and the output original identification information associated with the plural items of image information. The original identification information obtaining part uses a number to identify each sheet of paper of the original document, and when the image information obtaining part obtains each of the plural items of the image information, the original identification information obtaining part obtains the number as the original identification information to be used for identifying each sheet of paper of the original document from which each of the plural items of the image information is obtained.

According to another embodiment of the present invention, an image forming apparatus inputs image information into another system that handles the image information. The image forming apparatus includes an image information obtaining part that obtains plural items of image information that is generated as a result of plural sheets of paper of an original document being read and an original identification information obtaining part that obtains original identification information to be used for identifying each sheet of paper of the original document, for each of the obtained plural items of image information. The image forming apparatus also includes an information output part that associates the obtained plural items of image information and the original identifying information obtained for each of the plural items of image information, and outputs it. The original identification information obtaining part uses a number to identify each sheet of paper of the original document, and when the image information obtaining part obtains each of the plural items of the image information, the original identification information obtaining part obtains the number as the original identification information to be used for identifying each sheet of paper of the original document from which each of the plural items of the image information is obtained.

According to yet another embodiment of the present invention, an image information input method of inputting image information into another system that handles the image information. The image information input method includes temporarily storing, in a storage medium, plural items of image information that is generated as a result of plural sheets of paper of an original document being read and temporarily storing, in the storage medium, a number to be used to identify each sheet of paper of the original document, and when storing each of the plural items of the image information, temporarily storing the number as the original identification information to be used for identifying each sheet of paper of the original document from which each of the plural items of the image information is obtained. The image information input method further includes reading, from the storage medium, the plural items of image information and the original identifying information stored for each of the plural items of image information, associating the plural items of image information and the original identifying information stored for each of the plural items of image information, and outputting it. The image information input method yet further includes storing, in a storage apparatus, the output plural items of image information and the output original identification information associated with the plural items of image information.

Other aspects, features and advantages of the present invention will become more apparent from the following detailed description when read in conjunction with the accompanying drawings.

### BRIEF DESCRIPTION OF THE DRAWINGS

FIG. 1 shows a mode of operating a system according to an embodiment of the present invention;

FIG. 2 is a block diagram that schematically shows a hardware configuration of an image forming apparatus according to the embodiment of the present invention;

FIG. 3 is a block diagram that shows a functional configuration of the image forming apparatus according to the embodiment of the present invention;

FIG. 4 is a sequence diagram that shows an operation of the system according to the embodiment of the present invention;

FIG. 5 is a flowchart that shows an operation of a document information generation part according to the embodiment of the present invention;

FIGS. 6 and 7 show examples of document information according to the embodiment of the present invention;

FIGS. 8 and 9 show examples of displaying on a display panel according to the embodiment of the present invention;

FIG. 10 shows a flowchart that shows an operation of a document information generation part according to a first variant embodiment of the embodiment of the present invention; and

FIG. 11 shows a flowchart that shows an operation of a document information generation part according to a second variant embodiment of the embodiment of the present invention.

### DETAILED DESCRIPTION OF THE EMBODIMENTS

An embodiment of the present invention has been devised for solving the above-mentioned problems, and an aspect of the embodiment of the present invention is to make it possible to easily determine a document from which an image has been obtained, even when the image is included in images that have been generated as a result of many types of documents being scanned at the same time.

Below, with reference to the figures, embodiments of the present invention will be described in detail. According to a one embodiment of the present invention, as an example of an image processing system, an image input system is used in which an image read by a scanner connected via a communication network is stored in a server also connected via the communication network.

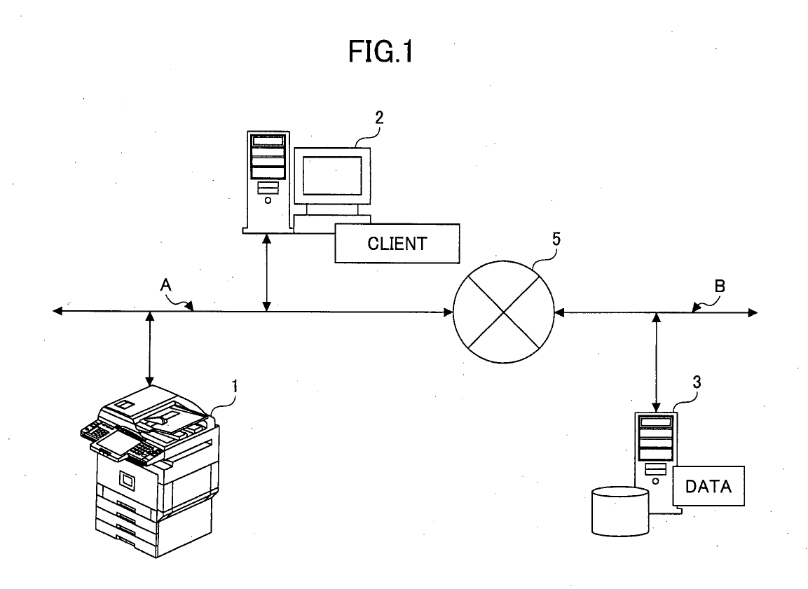

FIG. 1 shows one example of a mode of operating a system according to one embodiment of the present invention. The system according to the one embodiment of the present invention is such that a communication network A to which an image forming apparatus 1 and a client terminal 2 are connected and a communication network B to which a data server 3 is connected are connected together via a public circuit 5 such as the Internet, a telephone line or such. The system according to one embodiment functions as an image information input system which generates image information as a result of the image forming apparatus 1 reading an original document, and storing the image information in the data server 3. It is noted that hereinafter, “sheets of paper of an original document” may mean either sheets of paper of a single document or sheets of paper of plural documents.

In the one embodiment of the present invention, both the communication networks A and B are communication networks of a service user who uses the image information input system. The communication network A is a communication network of a branch office or a sales branch, for example, and the communication network B is a communication network of a central office or a center, for example. The communication networks A and B are connected to the public circuit 5 via network apparatuses such as routers (not shown).

The image forming apparatus 1 is a multifunction peripheral that has an image reading function, an image forming function, a communication function, and so forth, and can be used as a printer, a facsimile machine, a scanner and a copier. Further, the image forming apparatus 1 also functions as a user interface that is used for inputting an instruction to execute a workflow that has been previously registered. The client terminal 2 is an information processing terminal that the user operates, and may take the form of an information processing apparatus such as a PC (Personal Computer).

The data server 3 is a server that is an information storage apparatus, in which image information processed by the image forming apparatus 1 is stored. That is, the data server 3 may belong to a system which is different from the image forming system according to one embodiment of the present invention, and may be such as a basic business system or such of the service user. In the image information input system such as that shown in FIG. 1, a feature is to consider linking with the system of the service user to which the data server 3 belongs. It is noted that in FIG. 1, the data server 3 is shown as being a single apparatus. However, the function of the data server 3 may be plural apparatuses.

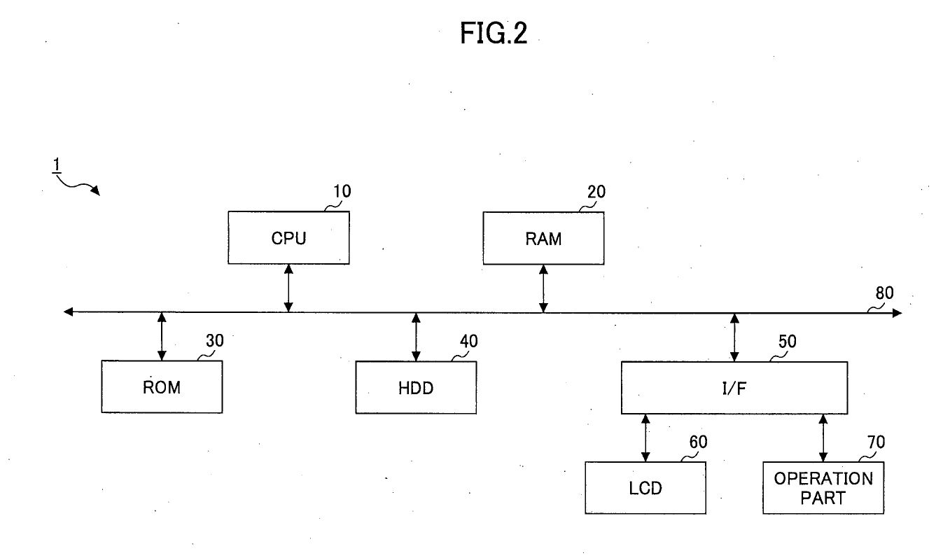

Next, hardware configurations of the image forming apparatus 1, the client terminal 2 and the data server 3 will be described. FIG. 2 is a block diagram showing a hardware configuration of the image forming apparatus 1 according to one embodiment of the present invention. It is noted that the image forming apparatus 1 includes engines for functions of a scanner, a printer, and so forth (not shown), in addition to the hardware configuration shown in FIG. 2. Below, the hardware configuration of the image forming apparatus 1 will be described. However, each of the hardware configurations of the client terminal 2 and the data server 3 is the same as or similar to the hardware configuration of the image forming apparatus 1, and duplicate description therefor will be omitted as is appropriate.

As shown in FIG. 2, the image forming apparatus 1 has a configuration the same as a configuration of a common server or PC. That is, the image forming apparatus 1 according to the one embodiment of the present invention includes a CPU (Central Processing Unit) 10, a RAM (Random Access Memory) 20, a ROM (Read Only Memory) 30, a HDD (Hard Disk Drive) 40, and an I/F (interface) 50, which are all connected via a bus 80. Further, a LCD (Liquid Crystal Display) and an operation part 70 are connected to the I/F 50.

The CPU 10 is an arithimetic and logic operation part, and controls operation of the entirety of the image forming apparatus 1. The RAM 20 is a volatile storage medium, from which information can be read and to which information is written at high speed, and is used as a work area when the CPU 10 processes information. The ROM 30 is a non-volatile storage medium specially for reading information therefrom, and stores programs such as firmware. The HDD 40 is a non-volatile storage medium, from which information can be read and to which information is written, and stores various control programs such as an OS (Operating System), application programs, and so forth.

The I/F 50 connects various hardware parts/components and communication networks with the bus 80, and controls them. The LCD 60 acts as a visual user interface for the user to check the state of the image forming apparatus 1. The operation part 70 acts as a user interface that includes a keyboard, a mouse, and so forth, for the user to input information to the image forming apparatus 1. It is noted that as described above with reference to FIG. 1, the data server 3 according to the one embodiment is operated as a server. Therefore, in the data server 3, the user interfaces such as the LCD 60 and the operation part 70 may be omitted.

In the hardware configuration described above, a program stored by the ROM 30, the HDD 40, or a storage medium such as an optical disk (not shown), is read out to the RAM 20, and executed by the CPU 10 which then performs the corresponding functions. Thus, a software control part is realized. By a combination of the software control part and the hardware, functional blocks that perform functions for each of the image forming apparatus 1 and the data server 3 are realized.

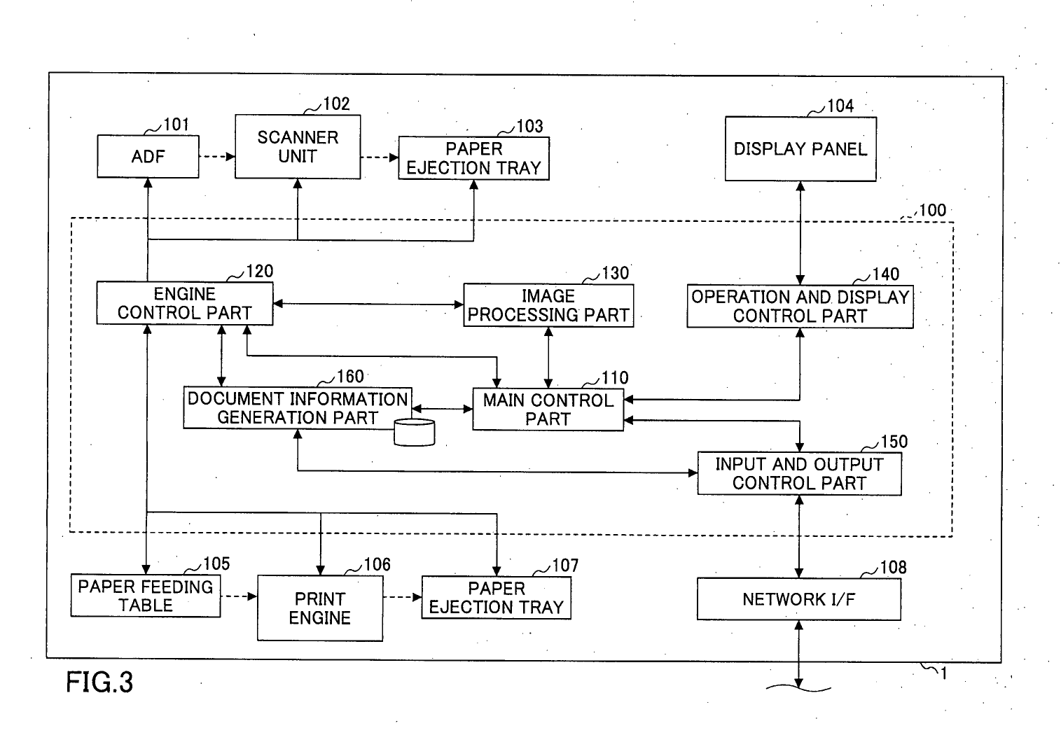

Next, a functional configuration of the image forming apparatus 1 according to one embodiment of the present invention will be described with reference to FIG. 3. FIG. 3 is a block diagram showing the functional configuration of the image forming apparatus 1 according to one embodiment of the present invention. As shown in FIG. 3, the image forming apparatus 1 according to one embodiment of the present invention includes a controller 100, an ADF (Automatic Document Feeder) 101, a scanner unit 102, a paper ejection tray 103, a display panel 104, a paper feeding table 105, a print engine 106, a paper ejection tray 107 and a network I/F 108.

The controller 100 includes a main control part 110, an engine control part 120, an image processing part 130, an operation and display control part 140, an input and output control part 150 and a document information generation part 160. As shown in FIG. 3, the image forming apparatus 1 according to one embodiment of the present invention is configured as a multifunction peripheral that includes the scanner unit 102 and the print engine 106. It is noted that in FIG. 3, solid-line arrows represent electrical connections, and broken-line arrows represent the flow of paper or a document.

The display panel 104 acts as an output interface that visually displays the state of the image forming apparatus 1, and also, acts as an input interface that is a touch panel, for example, with which the user directly operates the image forming apparatus 1 and/or the user inputs information to the image forming apparatus 1. That is, the display panel has a function of displaying an image (screen page) for receiving the user's operation. The display panel 104 equates to the LCD 60 and the operation part 70 shown in FIG. 2. According to one embodiment of the present invention, the user operates the display panel 104, and gives instructions for scanning an original document and execution of a workflow.

The network I/F 108 is an interface to be used when the image forming apparatus 1 communicates with another apparatus such as the client terminal 2 or the data server 3 via the communication network, and for this purpose, an Ethernet (registered trademark) or a USB (Universal Serial Bus) interface may be used. The network I/F 108 equates to the I/F 50 shown in FIG. 2. Further, the network I/F 108 includes a facsimile modem and functions as an interface used when the image forming apparatus 1 carries out facsimile transmission and reception via the communication network.

The controller 100 is configured using combination of software and hardware. Specifically, the controller 100 is configured by a software control part that is configured as a result of a program stored in a non-volatile memory such as the ROM 30 or a non-volatile storage medium such as the HDD 40 or an optical disk being loaded into a volatile memory such as the RAM 20 (simply referred to as a memory hereinafter), and the CPU 10 operating according to the program; and hardware such as an integrated circuit. The controller 100 functions as a control part that controls the entirety of the image forming apparatus 1.

The main control part 110 performs the function of controlling the respective parts included in the controller 100, and gives instructions to the respective parts included in the controller 100. The engine control part 120 performs the function of a driving part that controls or drives the print engine 106, the scanner unit 102, and so forth. The image processing part 130 generates drawing information based on image information which is to be printed and output, under the control of the main control part 110. The drawing information is information, according to which the print engine 106 that acts as an image forming part, draws an image to be formed in an image forming operation.

The image processing part 130 processes image reading data input from the scanner unit 103, and generates image data (image information). The image data is information that is obtained through a scanning operation of the scanner unit 102 and is stored in a storage area of the image forming apparatus 1 or is transmitted to the data server 3 via the network I/F 108.

The operation and display control part 140 displays information on the display panel 104, or notifies the main control part 110 of information that is input from the display panel 104. The input and output control part 150 inputs information that is input via the network I/F 108 into the main control part 110. Further, the main control part 110 controls the input and output control part 150, and accesses another apparatus such as the client terminal 2 or the data server 3 via the network I/F 108 and the communication network.

The document generation part 160 generates document information concerning a document that is an original document of an image (image information) generated when the scanner unit 102 scans the original document according to the control of the engine control part 120. The document information generation part 160 according to an embodiment of the present invention generates document information to be used for identifying each sheet of paper of the original document (or each page of the original document) for each of plural images, when the plural images (plural items of image information) are generated as a result of plural pages of the document (the original document) being scanned. The document information generated by the document information generation part 160 is used in the system to which the data server 3 belongs as information to be used for determining whether each page of the plural images corresponds to an image of a single-sided page of the original document or an image of a double-sided page of the original document.

In a case where the image forming apparatus 1 acts as a printer, first the input and output control part 150 receives a printing job via the network I/F 108. The input and output control part 150 transfers the received printing job to the main control part 110. When receiving the printing job, the main control part 110 controls the image processing part 130 and generates drawing information based on image information included in the printing job.

When the drawing information is thus. generated by the image processing part 130, the engine control part 120 controls the print engine 106, and causes the print engine 106 to carry out forming an image according to the generated drawing information on paper that is conveyed from the paper feeding table 105. As a specific configuration of the print engine 106, an image forming mechanism according to an ink jet system, an image forming mechanism according to an electrophotographic system, or such, may be used. A document having the image formed by the print engine 106 is ejected to the paper ejection tray 107.

In a case where the image forming apparatus 1 acts as a scanner, in response to a scanning execution instruction input as a result of the user operating the display panel 104 or being input from an external apparatus via the network I/F 108, the operation and display control part 140 or the input and output control part 150 transfers the scanning execution signal to the main control part 110. The main control part 110 controls the engine control part 120 based on the received scanning execution signal.

The engine control part 120 drives the ADF 101, and the ADF 101 conveys a page of the original document, which has been set in the ADF 101 and from which an image is to be read, to the scanner unit 102. Further, the engine control part 120 drives the scanner unit 102, and the scanner unit 102 reads the image from the page of the original document having been conveyed from the ADF 101. In a case where the page of the original document is not set in the ADF 101 but is directly set to the scanner unit 102, the scanner unit 102 reads the image from the page of the original document under the control of the engine control part 120. That is, the scanner unit 102 operates as an image reading part and the engine control part 120 functions as a reading control part. It is noted that in the above-mentioned case where the page of the original document is directly set to the scanner unit 102, a press plate (not shown) of the scanner unit 120 is used to press the page of the original document onto the scanner unit 102 to prevent the page of the original document from moving during the scanning operation of the scanner unit 102.

In the image reading operation of the scanner unit 102, an image pickup device such as a CCD (Charge Coupled Device) included in the scanner unit 102 optically scans the original document, and image reading information generated based on thus-obtained optical information is generated. The engine control part 120 transfers the image reading information generated by the scanner unit 102 to the image processing part 130. The image processing part 130 generates image information based on the image reading information received from the engine control part 120 according to the control of the main control part 110.

The image information generated by the image processing part 130 is then obtained by the main control part 110, and the main control part 110 stores the obtained image information in a storage medium such as a HDD 40 loaded in the image forming apparatus 1. That is, the scanner unit 102, the engine control part 120 and the image processing part 130 work together to function as an image input part, and also, the main control part 110 functions as an image information obtaining part. The image information generated by the image processing part 130 is stored as it is in the HDD 40 or such in response to the user's instruction, or is transmitted to an external apparatus such as the data server 3 via the input and output control part 150 and the network I/F 108.

Further, in a case where the image forming apparatus 1 operates as a copier, the image processing part 130 generates drawing information based on image reading information received by the engine control part 120 from the engine control part 102 or image information generated by the image processing part 130. Based on the drawing information, the same as in the case of the above-mentioned printer operation, the engine control part 120 drives the print engine 106. It is noted that in a case where an information format is the same between the drawing information and the image reading information, the image reading information can be used as the drawing information just as it is.

Further, in a case where the image forming apparatus 1 operates as a facsimile machine, first, the same as in the case of the above-mentioned scanner operation, the image processing part 130 generates image information. Then, the main control part 110 controls the input and output control part 150, and causes the input and output control part 150 to carry out facsimile transmission. When the facsimile transmission is to be carried out, the input and output control part 150 drives the function of the facsimile modem included in the network I/F 108, and transmits the image to a designated transmission destination according to the control of the main control part 110.

In the system including the image forming apparatus 1 according to one embodiment of the present invention described above, the document information generation part 160 generates information such that linking to the other system to which the data server 3 belongs can be carried out easily, especially with regard to handling image information. There, the image information is stored into the data server 3 as a result of the image information being obtained through scanning and being delivered to the data server 3. Below, the operation of the system according to one embodiment of the present invention will be described.

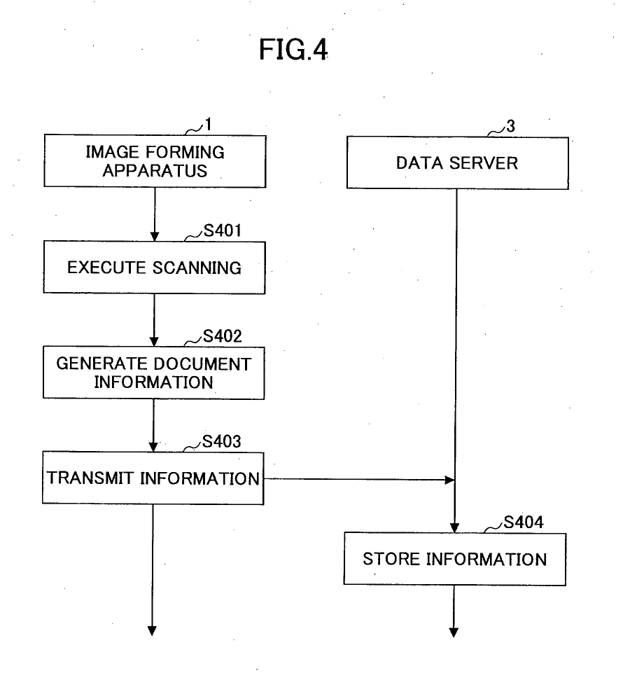

FIG. 4 is a sequence diagram showing the operation of the system according to one embodiment of the present invention. As shown in FIG. 4, when scanning is carried out in the image forming apparatus 1 (step S401), document information is generated by the document information generation part 160 of the image forming apparatus 1 (step S402). When the document information is thus generated, the image forming apparatus 1 transmits the image information obtained from the scanning and the document information to the data server 3 (step S403). Then, the data server 3 receives and stores the information (the image information and the document information) transmitted from the image forming apparatus 1 (step S404).

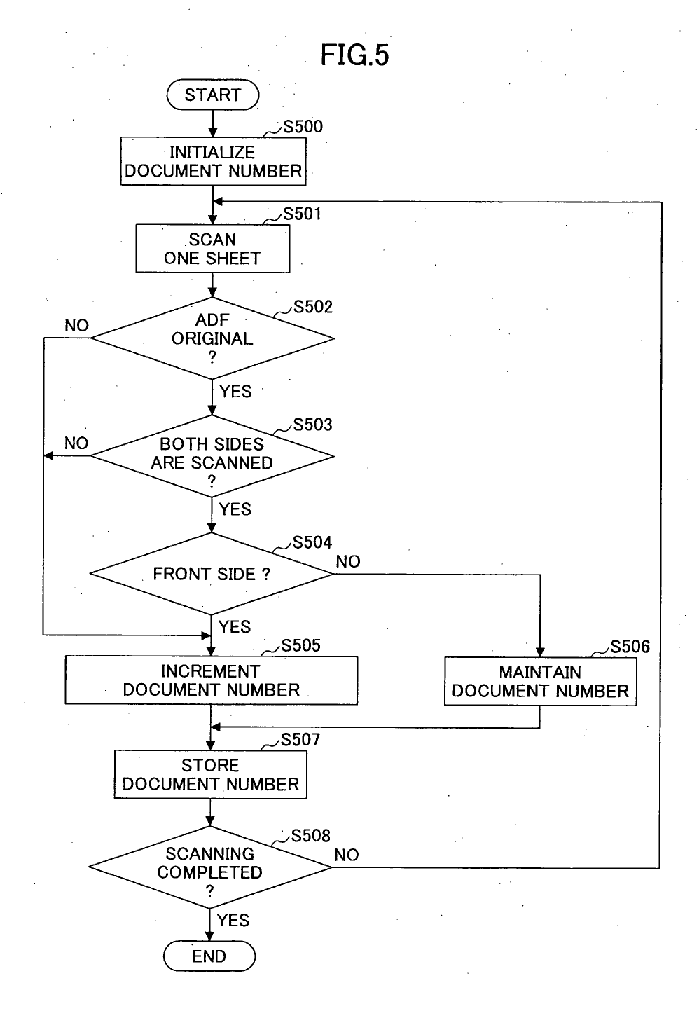

Next, the operation of generating the document information when the scanning is carried out in the image forming apparatus 1 will be described with reference to FIG. 5. As shown in FIG. 5, after the document information generation part 160 initializes a document number (described later) to “0” and stores the initialized document number (step S500), when one page of an original document is scanned by the scanner unit 102 according to the control of the engine control part 120 (step S501), the document generation part 160 obtains information from the engine control part 120, and determines whether the current scanning is scanning of the page of the original document that is set in the ADF 101 or scanning of the page of the original document that is set to the press plate of the scanning unit 102 (step S502).

As described above, scanning of the scanner unit 102 is carried out according to the control of the engine control part 120, and therefore, the engine control part 120 recognizes whether the currently executed scanning is scanning of a page of an original document that is set in the ADF 101 or scanning of a page of an original document that is set to the press plate of the scanning unit 102. Therefore, in -step S502, the engine control part 120 controls the scanner unit 102 to carry out scanning, and also, inputs information indicating a position to which the scanned page of the original document has been set (hereinafter, referred to as original set position information) into the document information generation part 160.

Then, in step S502, the document information generation part 160 determines whether the current scanning is scanning of the page of the original document set in the ADF 101 or scanning of the page of the original document set to the press plate of the scanner unit 102, based on the original set position information thus input from the engine control part 120. Specifically, in a case where the original set position information indicates the ADF 101 as the position to which the original document has been set, the document information generation part 160 determines that the current scanning is scanning of the page of the original document set in the ADF 101. On the other hand, in a case where the original set position information indicates the press plate of the scanner unit 102 as the position to which the page of the original document has been set, the document information generation part 160 determines that the current scanning is scanning of the page of the original document set to the press plate of the scanner unit 102. It is noted that as the original set position information, it is possible to use a signal of one bit to indicate the ADF 101 or the press plate of the scanner unit 102 by a “High” level or a “Low” level of the signal.

In a case where the current scanning is scanning of the page of the original document set to the press plate of the scanner unit 102 (step S502 NO), the document information generation part 160 recognizes that the sheet of paper of the original document has been changed (or has been newly set), and increments the stored document number by 1 (step S505).

In a case where the current scanning is scanning of the page of the original document set in the ADF 101 (step S502 YES), the document information generation part 160 next determines whether the current scanning is double-sided scanning or single-sided scanning (step S503). In a common ADF, a mechanism of reversing a sheet of paper of an original document is provided, and double-sided scanning can be achieved as a result of a sheet of paper of an original document being automatically reversed by the mechanism of the ADF 101. According to the embodiment of the present invention, the document information generation part 160 obtains information indicating whether the current scanning is double-sided scanning or single-sided scanning (hereinafter, referred to as scanning side information) from the engine control part 120, and thus, the document information generation part 160 determines whether the currently executed scanning is double-sided scanning or single-sided scanning. It is noted that double-sided scanning means that both the front side and the back side of a sheet of paper of an original document are scanned, and single-sided scanning means that only one side (either the front side of the back side) of a sheet of paper of an original document is scanned.

That is, in step S503, the document information generation part 160 determines whether the current scanning is double-sided scanning or single-sided scanning, based on the scanning side information input from the engine control part 120. Specifically, in a case where the scanning side information indicates single-sided scanning, the document information generation part 160 determines that the current scanning is single-sided scanning. On the other hand, in a case where the scanning side information indicates double-sided scanning, the document information generation part 160 determines that the current scanning is double-sided scanning. It is noted that, the same as the above-mentioned original set position information, it is possible to use a signal of one bit to indicate double-sided scanning or single-sided scanning by a “High” level or a “Low” level of the signal.

Also in step S503, the same as in step S502, the engine control part 120 inputs into the document information generation part 160 information indicating whether the currently executed scanning is double-sided scanning or single-sided scanning, and further, in the case of double-sided scanning (step S503 YES), the engine control part 120 inputs into the document information generation part 160 information indicating whether the currently executed scanning is scanning of the front side or scanning of the back side of the sheet of paper of the original document. In a case where the currently executed scanning is single-sided scanning (step S503 NO), the document information generation part 160 recognizes that the sheet of paper of the original document has been changed (or has been newly set), and increments the stored document number by 1 (step S505). In a case where the currently executed scanning is double-sided scanning (step S503 YES), the document information generation part 160 then determines whether the current scanning is scanning of the front side or scanning of the back side of the sheet of paper of the original document (step S504). The document information generation part 160 according to an embodiment of the present invention counts the document number for identifying each scanned sheet of paper of the original document. Then, when scanning is carried out, each time the sheet of paper of the original document has been changed (or has been newly set), the document information generation part 160 increments the document number by 1, and stores the incremented document number. That is, in a case of scanning of the front side (step S5504 YES), the document information generation part 160 recognizes that the sheet of paper of the original document has been changed, and increments the stored document number by 1 (step S505).

On the other hand, in a case of scanning of the back side (step S504 NO), since the sheet of paper of the original document has not been changed, the document information generation part 160 maintains the document number as it is (step S506). That is, in the case where the current scanning is scanning of the back side, this means that the previous scanning is scanning of the front side of the same sheet of paper of the original document. This is the reason why in the case of scanning of the back side (step S504 NO), the sheet of paper of the original document has not been changed. After the completion of step S505 or S506, the document information generation part 160 stores the stored document number as information to be used for identifying the sheet of paper of the original document from which the image has been generated through scanning (step S507). The document information generation part 160 functions as an original identification information obtaining part. It is noted that, the destination in which the document information generation part 160 stores the document number in step S507 is the RAM 20, for example.

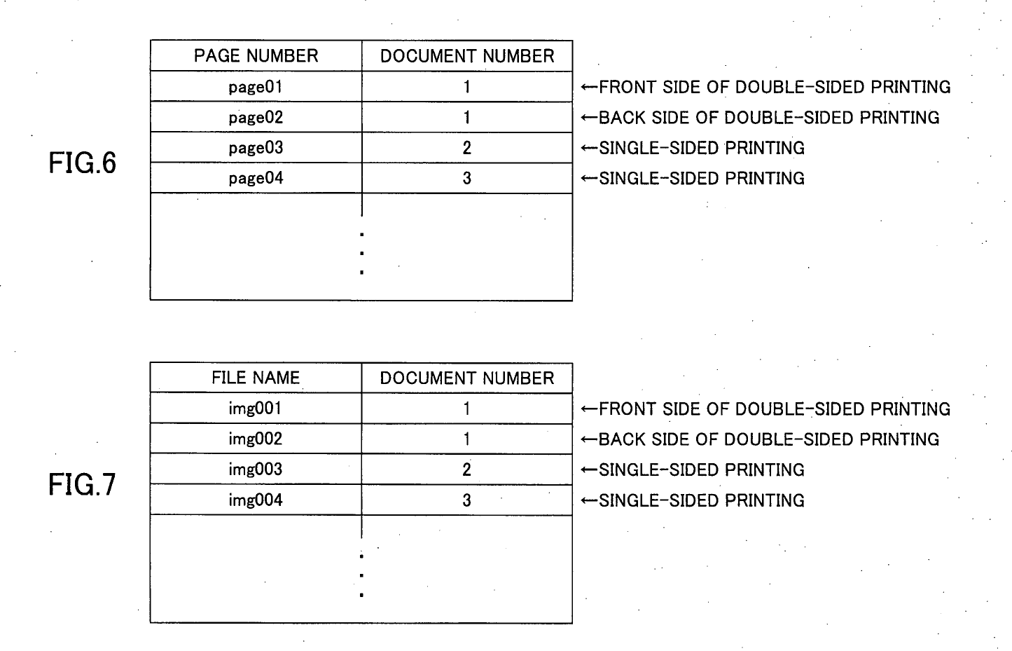

In step S507, the document information generation part 160 stores the document number in such a manner that the document number is associated with information that designates the image (image information) generated through the current scanning (step S501). The information that designates the image generated through the current scanning depends on a specific method of the scanning (i.e., a multi-page method or a single-page method), and details thereof will be described later with reference to FIGS. 6 and 7. The information in which the document number and the information designating the image are associated is used as the document information. That is, the document information generation part 160 also functions as an information output part that outputs to the RAM 20 the image information generated through scanning and the document number obtained for each item (each page) of the image information in such a manner that the image information and the document number are associated.

After step S507, when scanning has been completed for all of the sheets of paper of the original document set in the ADF 102 or scanning has been completed for the sheet of paper of the original document set to the press of the scanner unit 102 (step S508 YES), the process is finished. When scanning has not yet been completed for all of the sheets of paper of the original document set in the ADF 102 and scanning has not yet been completed for the sheet of paper of the original document set to the press of the scanner unit 102 (step S508 NO), the process is repeated from step S501. By the above-described process, the operation of generating the document information according to an embodiment of the present invention is finished. That is, as mentioned above, the document information generation part 160 functions as the information output part.

FIG. 6 shows one example of the document information generated in the operation of FIG. 5. The example of FIG. 6 is an example of the document information which is generated to correspond to image information in the multi-page method which is generated through scanning such that plural pages of images are included in a single file as in the format of PDF (Portable Document Format). As shown in FIG. 6, in the document information according to an embodiment of the present invention, a “page number” indicating a page of image information and a “document number” to be used to identify each sheet of paper of the original document from which the image information is obtained are associated.

In the example of FIG. 6, the document number of the first page, “page01”, is “1”, and the document number of the second page, “page02”, is also “1”. Thus, it is indicated that the images having the page numbers “page01” and “page02” are images of the front side and the back side of the same sheet of paper of the original document, respectively. On the other hand, in FIG. 6, the document number of the third page, “page03”, is “2”, and the document number of the fourth page, “page04”, is That is, the different document numbers “2” and “3” are given to the images having the page numbers of “page03” and “page04”, respectively. Thereby, it is indicated that the images having the page numbers “page03” and “page04” are images on one sides of different sheets of paper of the original document, respectively.

It is noted that, other than the example of FIG. 6, it is also possible that in order to indicate the front side and the back side of the same sheet of paper of the original document, symbols such as “a” and “b” may be attached to the document numbers, as “1a” and “1b”, for example. Thereby, it is possible that in the subsequent system using the document information, it can be easily determined whether an image is an image of the front side or the back side of a sheet of paper of the original document.

FIG. 7 shows another example of the document information which is generated to correspond to image information in the single-page method which is generated through scanning such that a single page of an image is included in a single file as in the format of JPEG (Joint Photographic Expert Group). In the example of FIG. 7, instead of “page number” in the example of FIG. 6, a “file name” and a “document number” are associated. In a case where image information in the single-page method is used and plural pages of an original document are scanned, generally speaking, file names are given to image data as “ime001”, “img002”, img003”, . . . , for example. Therefore, in the document information corresponding to image information according to the single-page method, file names are designated from the first page in sequence, and document numbers stored when images (image information) designated by the file names are generated through scanning are associated with the file names, respectively.

The document information such as that shown in FIG. 6 or FIG. 7 is stored in the data server 3 together with the image information generated through scanning. Thereby, in the data server 3 and in the system to which the data server 3 belongs, it can be easily determined whether the image generated through scanning is the image generated through double-sided scanning or the image generated through single-sided scanning. Further, in either image information in the single-page method or image information in the multi-page method, it is possible to identify each sheet of paper of the original document from which the images are generated in a case where plural pages of the images are generated. It is noted that the document information such as those shown in FIGS. 6 and 7 may be generated in a format of XML (eXtensible Markup Language), for example.

Thus, in the system according to one embodiment of the present invention, as described above, the image forming apparatus 1 that carries out scanning of sheets of paper of an original document generates the document information to be used for identifying each of the sheets of paper of the original document from which image information generated through scanning is generated, and delivers the document information together with the generated image information. Thereby, even in a case where plural types of original documents (or plural types of pages of an original document) are scanned at the same time and corresponding images are generated through scanning, it is possible to easily determine the document from which each of the images is generated.

As a specific method of attaching the document information to each item of image information, other than the above-mentioned case where as in one embodiment of the present invention the document information is generated separately from the corresponding image information, data such as the document information may be embedded as metadata in the corresponding image information or the document information may be embedded in the corresponding image information by using digital watermarking technology. In such a case, also in the subsequent system that processes the generated images (in the above-mentioned embodiment, the system to which the data server 3 belongs), a process of analyzing the metadath or the data embedded by using the digital watermarking technology is necessary.

In contrast thereto, in a case where the document information is generated as the data in a simple format such as text data depending on the subsequent system, separately from the corresponding image information, the subsequent system can easily read the document information, and thus, it is possible to easily achieve linking with a different system.

Further, in the above-mentioned embodiment, in the case where the current scanning is scanning of a sheet of paper of the original document set to the press plate of the scanner unit 102 (step S502 NO in FIG. 5), the process is carried out as the scanning is single-sided scanning. However, there may be a case where a sheet of a double-sided original document is set to the press plate of the scanner unit 102, and both sides of the sheet paper of the original document are scanned, respectively.

For example, in a case where an original document is an important document such as a contract document or a document of thin paper or such which is not suitable to be conveyed by means of a roller, the original document may be set to the press plate of the scanner unit 102 and may be scanned instead of using the ADF 101 that generally uses a roller to convey an original document, even when the sheet of paper of the original document is double sided and both sides of the sheet of paper of the original document are to be scanned. In such a case, there may be a case where information that the sheet of paper of the original document is double sided is reported to the subsequent system. However, in a case where the sheet of paper of the original document is set to the press plate of the scanner unit 102 and both sides of the sheet of paper of the original document are to be scanned, the sheet of paper of the original document is to be reversed manually by the user. Therefore, in scanning according to an ordinary operation, the engine control part 120 and the document information generation part 106 cannot determine whether the current scanning is scanning of the front side or the back side of the sheet of paper of the original document.

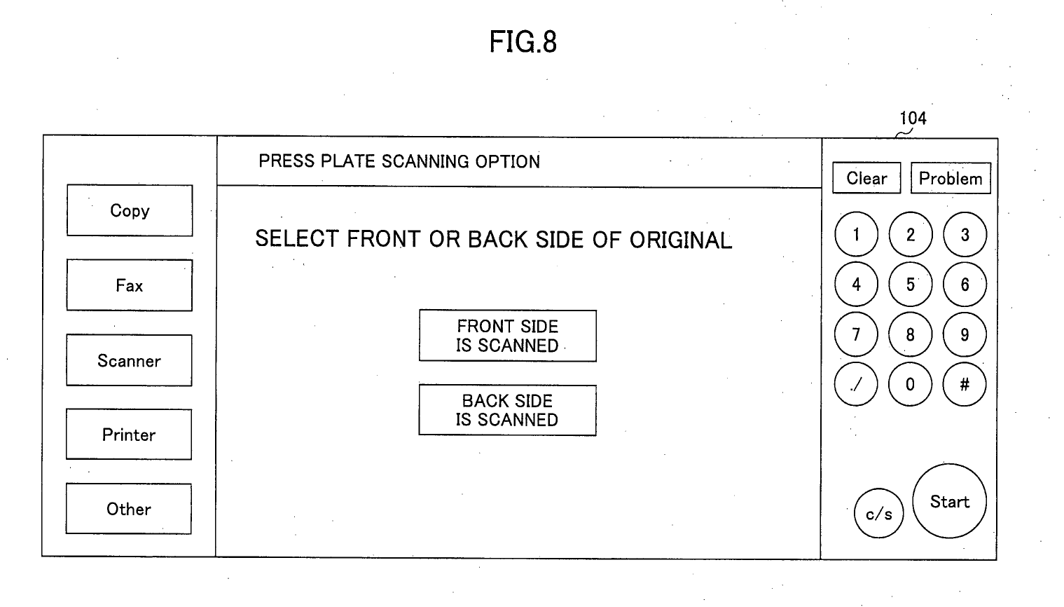

In contrast thereto, the maim control part 110 can recognize via the operation and display part 140 whether the currently executed scanning is scanning of the front side or the back side of the sheet of paper of the original document, when the operation and display control part 140 causes the display panel 104 to display a screen page as shown in FIG. 8 on a display screen of the display panel 104 for the user to select whether the current scanning is scanning of the front side (“FRONT SIDE IS SCANNED”) or the back side (“BACK SIDE IS SCANNED”), and the user operates the display panel 104 to select either scanning of the front side or scanning the back side from the screen page. Then, as the main control part 110 inputs into the document information generation part 160 the result of thus recognizing whether the currently executed scanning is scanning of the front side or the back side of the sheet of paper of the original document (hereinafter, simply referred to as scanning side designation information), the document information generation part 160 can determine whether the currently executed scanning is scanning of the front side or the back side of the sheet of paper of the original document, even in the case of scanning of the original document that is set to the press plate of the scanner unit 102.

Also in this case, a process similar to the process according to the flowchart of FIG. 5 may be carried out. That is, in a case where the user selects either scanning of the front side or scanning the back side from the screen page shown in FIG. 8, in a process corresponding to step S504 of FIG. 5, the document information generation part 160 determines whether the current scanning is scanning of the front side or the back side based on the scanning side designation information input from the main control part 110. That is, when the front side is designated in the scanning side designation information, the document information generation part 160 determines that the current scanning is scanning of the front side. On the other hand, when the back side is designated in the scanning side designation information, the document information generation part 160 determines that the current scanning is scanning of the back side.

In the example described above with reference to FIG. 8, it is assumed that the scanning is double-sided scanning and scanning with the press plate of the scanner unit 102. Therefore, when a process corresponding to step S502 of FIG. 5 is carried out in the case where the screen page of FIG. 8 is used and the above-mentioned scanning side designation information is input, the document information generation part 160 can automatically recognize that the current scanning is scanning with the press plate of the scanner unit 102. Similarly, when a process corresponding to step S503 of FIG. 5 is carried out, the document information generation part 160 can automatically recognize that the current scanning is of double-sided scanning. Therefore, it is possible to omit steps S502 and S503, and without regard to either scanning using the ADF 101 or scanning using the press plate of the scanner unit 102, it is possible to generate the document information to be used for identifying each sheet of paper of the original document from which the image information is generated through scanning. It is noted that in the example of FIG. 8, the operation and display control part 140 functions as a screen display control part that causes the screen page, for the user to designate whether a page of an original document to be read through scanning is the front side or the back side, to be displayed.

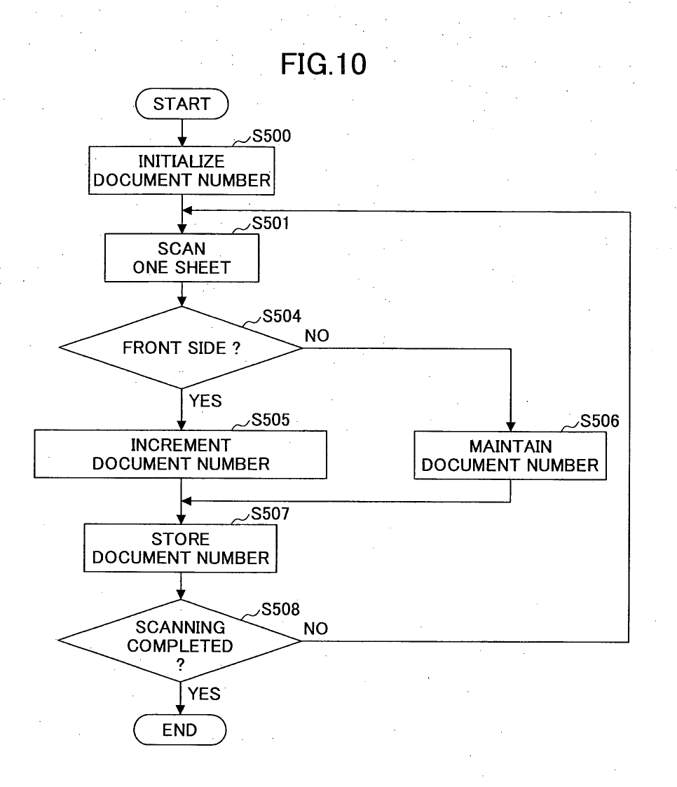

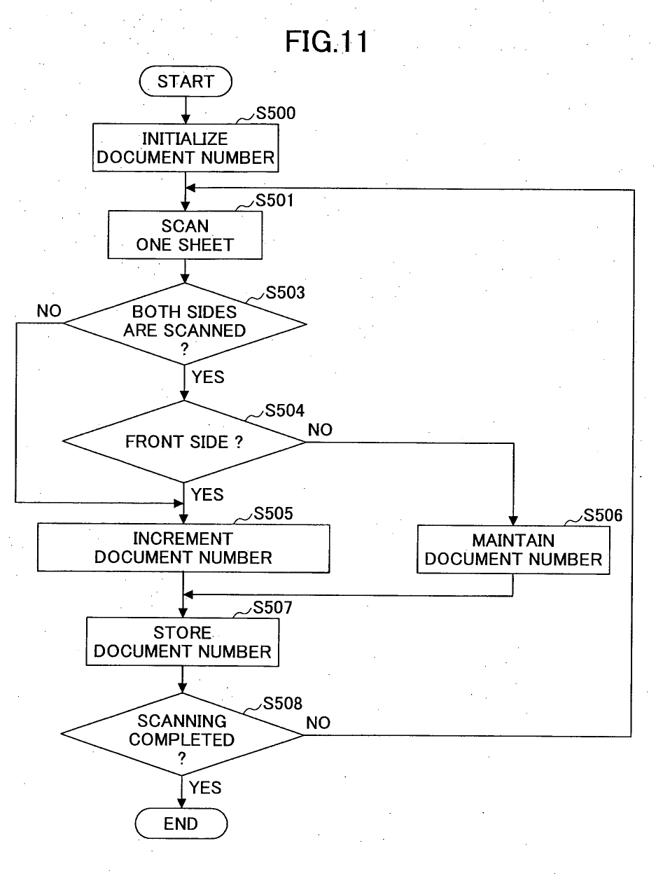

FIG. 10 shows an example of a flowchart according to a first variant embodiment of the present invention corresponding to the flowchart of FIG. 5 for a case where the above-mentioned scanning side designation information described above with reference to FIG. 8 is used. In FIG. 10, steps S500, S501, S504, S505, S506, S507 and S508, which correspond to steps S500, S501, S504, S505, S506, S507 and S508 of FIG. 5, respectively, have the contents generally identical to those of the corresponding steps of FIG. 5, respectively, and thus, duplicate description therefor will be omitted as is appropriate.

In the operation of FIG. 10, as mentioned above, in a case where the user selects either scanning of the front side or scanning of the back side from the. screen page shown in FIG. 8, in step S504 of FIG. 10, the document information generation part 160 correspondingly determines whether the current scanning is scanning of the front side or the back side based on the scanning side designation information input from the main control part 110. Further, in step S508 of FIG. 10, the document information generation part 160 determines that the scanning is not yet finished when the user selects scanning of the front side from the screen page shown in FIG. 8, and the document information generation part 160 determines that the scanning is finished when the user selects scanning of the back side from the screen page shown in FIG. 8. This is because generally speaking, in a case where a sheet of paper of a double-sided original document is scanned, the front side of the sheet of paper of the original document is scanned first, and then, the back side of the sheet of paper of the original document is scanned next. Therefore, when the user selects scanning of the front side from the screen page shown in FIG. 8, this means that the scanning of the sheet of paper of the original document is continued to scanning of the back side. On the other hand, when the user selects scanning of the back side from the screen page shown in FIG. 8, this means that the scanning of the sheet of paper of the original document is finished.

In the above-mentioned embodiments, it is assumed that in a case where scanning using the ADF 101 and scanning using the press plate of the scanner unit 102 are mixed, the user sets a sheet of paper of an original document manually at the time of switching between the scanning using the ADF 101 and the scanning using the press plate of the scanner unit 102. Thus, the manual operation is troublesome for the user. In contrast thereto, it is possible to reduce the labor of the user when scanning can be automatically carried out in such a state that sheets of paper of an original document are set to both the ADF 101 and the press plate of the scanner unit 102.

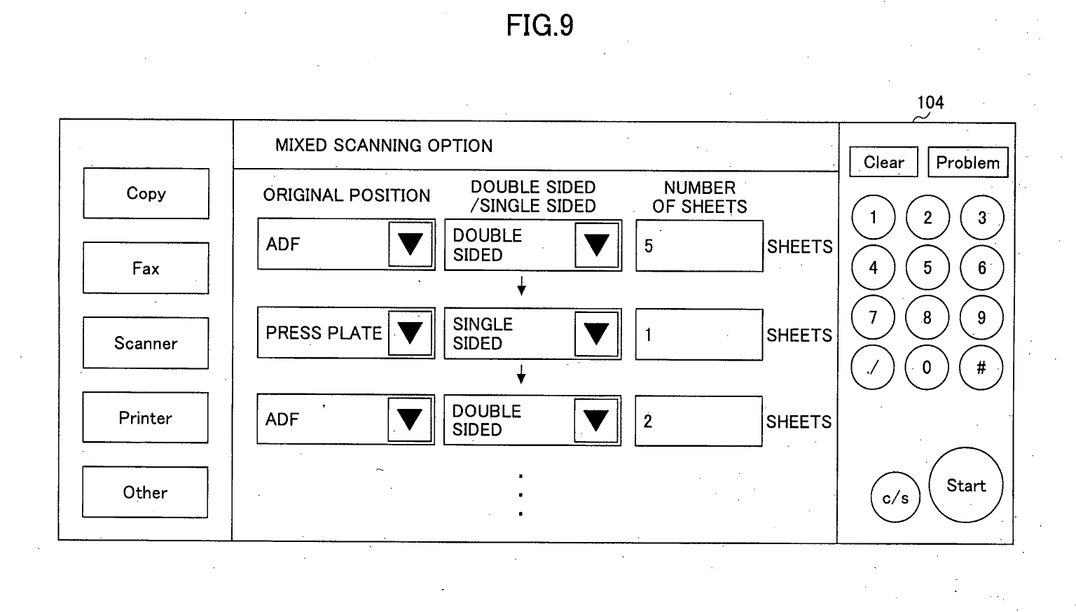

In this case, when the user previously inputs, to the image forming apparatus 1, information of the number and the order of sheets of paper of the original document to be scanned using the ADF 101 and the press plate of the scanner unit 102, and starts scanning, it is possible that based on the information that has been previously input by the user, the engine control part 120 can automatically select either the sheet of paper of the original document which is set in the ADF 101 or the sheet of paper of the original document which is set to the press plate of the scanner unit 102, and carry out scanning the selected sheet of the original document. FIG. 9 shows one example of an input screen page from which the above-mentioned information has been previously input by the user.

FIG. 9 shows an example of displaying on the display panel 104 on which a GUI (Graphical User Interface) of the input screen page for the user to input optional items for mixed scanning where sheets of paper of the original document are set to the respective ones of the ADF 101 and the press plate of the scanner unit 102. From the input screen page for the user to input the optional items for the mixed scanning shown in FIG. 9, information of “original position” indicating either the ADF 101 or the press plate of the scanner unit 102 to which the sheets of the original document are set, information of “double sided/single sided” and information of “number of sheets” is input by the user in sequence according to the order in which the sheets of paper of the original document are to be scanned. In the specific example of FIG. 9, as the information of “original position”, “ADF”, “press plate” and “ADF” are input, respectively, in sequence from the top. As the information of “double sided/single sided”, “double sided”, “single sided” and “double sided” are input, respectively, in sequence. As the information of “number of sheets”, “5”, “1” and “2” are input, respectively, in sequence. In this case, first, 5 sheets of paper of the original document which have been set in the ADF 101 are scanned, respectively, in double-sided scanning for each sheet of paper of the original document; 1 sheet of paper of the original document which has been set to the press plate of the scanner unit 102 is scanned in single-sided scanning; and further, 2 sheets of paper of the original document which have been set in the ADF 101 are scanned, respectively, in double-sided scanning for each sheet of paper of the original document.

In the case of FIG. 9, since scanning with the press plate of the scanner unit 102 requires only one sheet in single-sided scanning, the user does not need to replace the sheet of paper of the original document. Therefore, it is possible that scanning can be carried out automatically to the end, and thus, it is possible to considerably reduce the labor of the user. Further, even in a case where scanning with the press plate of the scanner unit 102 includes double-sided scanning, or scanning with the press plate of the scanner unit 102 includes scanning of plural sheets of paper of an original document, it is possible that, for scanning using the ADF 101, the user can previously sets the 5 sheets and the 2 sheets of paper of the original document in the ADF 101 at the same time, when the user previously inputs the number and the order of the sheets of paper of the original document as shown in FIG. 9. Thus, it is possible to omit the user's labor such as setting the 5 sheets in the ADF 101 first, carrying out scanning therefor, carrying out scanning with the press plate of the scanner unit 102, and then, setting the 2 sheets of the original document in the ADF 101.

In the case of using the screen page of FIG. 9 or such, the main control part 110 obtains via the operation and display control part 140 the information of “original position”, “double sided/single sided”, “number of sheets” and the order of scanning (hereinafter, referred to as scanning setting information), which is input from the screen page such as that shown in FIG. 9. The main control part 110 inputs the obtained scanning setting information into the engine control part 120. Thereby, the engine control part 120 can control the ADF 101 and the scanner unit 102, and carry out scanning according to the scanning setting information that is set by the user from the screen page such as that shown in FIG. 9.

The scanning setting information is also input into the document information generation part 160, and is used in operation of generating the document information. Also in this case a process similar to the process of the flowchart of FIG. 5 may be carried out. That is, when a process corresponding to step S502 of FIG. 5 is carried out, the document information generation part 160 determines, based on the information of “original position” of the scanning setting information, whether the scanning is scanning using the ADF 101. Further, when a process corresponding to step S503 of FIG. 5 is carried out, the document information generation part 160 determines, based on the information of “double-sided/single sided” of the scanning setting information, whether the scanning is double-sided scanning. In the example of FIG. 9, the document information generation part 160 can generate the document information based on the scanning setting information such as that shown in FIG. 9 which is input by the user, without carrying out steps S504 through S507. That is, since the scanning setting information that is input by the user achieves the two objects, i.e., the object of reducing the user's labor as a result of the engine control part 120 determining the order of scanning based on the scanning setting information and the object of generating the document information in the above-mentioned embodiment, it is possible to obtain a synergistic advantageous effect.

FIG. 11 shows one example of a flowchart according to a second variant embodiment of the present invention corresponding to the flowchart of FIG. 5 for a case where the above-mentioned scanning setting information described above with reference to FIG. 9 is used as mentioned above. In FIG. 11, steps S500, S501, S503, S504, S505, S506, S507 and S508, which correspond to steps S500, S501, S503, S504, S505, S506, S507 and S508 of FIG. 5, respectively, have the contents generally identical to those of the corresponding steps of FIG. 5, respectively, and thus, duplicate description therefor will be omitted as is appropriate.

In the operation of FIG. 11, for scanning operation according to the information of “double-sided/single sided” of the scanning setting information described above with reference to FIG. 9 being “double sided”, a determination result of step S503 is YES, and a determination result of step S504 is such that YES and NO occur alternately either in a case of scanning using the ADF 101 or in a case of scanning using the press plate of the scanner unit 102. On the other hand, for the scanning operation according to the information of “double-sided/single sided” of the scanning setting information described above with reference to FIG. 9 being “single sided”, a determination result of step S503 is NO accordingly.

Further, in the above-mentioned embodiments, the image information and the document information is transmitted from the image forming apparatus 1 to the data server 3 directly. However, an embodiment of the present invention is not limited to this example. Other than this example, images (image information) may be stored into the data server 3 via another server that carries out image processing such as OCR (Optical Character Recognition), conversion of the format of the image information, or so. Also in this case, by applying the above-mentioned embodiments, the same advantageous effects can be obtained. At this time, as to the document information itself for which no such image processing needs to be carried out, the document information may be transmitted directly from the image forming apparatus 1 to the data server 3, or may be transmitted from the image forming apparatus 1 to the data server 3 via the other server together with the image information.

The present invention is not limited to the specifically disclosed embodiments, and variations and modifications may be made without departing from the scope of the present invention.

The present application is based on Japanese Priority Patent Applications Nos. 2010-154992 and 2010-286145 filed on Jul. 7, 2010 and Dec. 22, 2010, respectively, the entire contents of which are hereby incorporated herein by reference.

What is claimed is:

1. An image information input system which inputs image information into another system that handles the image information, the image information input system comprising:
an image information obtaining part configured to obtain plural items of image information generated as a result of plural sheets of paper of an original document being read;
an original identification information obtaining part configured to obtain, for each of the obtained plural items of image information, original identification information used for identifying each sheet of paper of the original document;
an information output part configured to associate the obtained plural items of image information and the original identifying information obtained for each of the plural items of image information, and output it; and
an information storage part configured to store the output plural items of image information and the output original identification information associated with the plural items of image information, wherein
the original identification information obtaining part is configured to use a number to identify each sheet of paper of the original document, and when the image information obtaining part obtains each of the plural items of the image information, the original identification information obtaining part is configured to obtain the number as the original identification information to be used for identifying each sheet of paper of the original document from which each of the plural items of the image information is obtained.

2. The image information input system as claimed in claim 1, wherein
when the image information obtaining part obtains each of the plural items of image information, the original identification information obtaining part is configured to determine whether reading of the original document at the time the obtained item of the plural items of image information is generated is reading of both sides of the sheet of paper, and update the number according to this determination.

3. The image information input system as claimed in claim 2, wherein
in a case where the reading of the sheet of paper of the original document at the time the obtained item of the plural items of image information is generated is reading of both sides of the sheet of paper, the original identification information obtaining part is further configured to determine whether the reading of the sheet of paper of the original document at the time the obtained item of the plural items of image information is generated is reading of a front side or a back side of the sheet of paper, and increment the number when the reading of the sheet of paper of the original document at the time the obtained item of the plural items of image information is generated is reading of the front side of the sheet of paper.

4. The image information input system as claimed in claim 2, further comprising:
a reading control part configured to control an original reading part that reads the original document, wherein
the original identification information obtaining part is configured to obtain, from the reading control part, information to be used to determine whether the reading of the original document at the time the obtained item of the plural items of image information is generated is reading of both sides of the sheet of paper of the original document.

5. The image information input system as claimed in claim 2, further comprising:
a reading control part configured to control an original reading part that reads the original document, wherein
the original identification information obtaining part is configured to obtain, from the reading control part, information to be used to determine whether the reading of the original document at the time the obtained item of the plural items of image information is generated is reading of a front side or a back side of the sheet of paper of the original document, and in a case where the reading of the original document at the time the obtained item of the plural items of image information is generated is reading of both sides of the sheet of paper, the original identification information obtaining part is further configured to determine whether the reading of the original document at the time the obtained item of the plural items of image information is generated is reading of the front side or the back side of both sides of the sheet of paper, and increment the number when the reading of the original document at the time the obtained item of the plural items of image information is generated is reading of the front side of the sheet of paper.

6. The image information input system as claimed in claim 3, further comprising:
a screen display control part configured to cause a screen page for a user to designate whether the front side or the back side of the sheet of paper of the original document is read, wherein
the original identification information obtaining part is configured to obtain information to be used to determine whether the front side or the back side of the sheet of paper of the original document is read, based on the user's designation obtained from the screen page.

7. The image information input system as claimed in claim 1, wherein
the plural items of image information includes image information generated according to a multi-page method, and
the information output part is configured to output information in which information designating each page of the image information and information to be used for identifying each sheet of paper of the original document from which each page of the image information is obtained are associated.

8. The image information input system as claimed in claim 1, wherein
the plural items of image information includes plural items of image information generated according to a single-page method, and
the information output part is configured to output information in which information designating each of the plural items of image information generated. according to the single-page method and information to be used for identifying each sheet of paper of the original document from which each of the plural items of the image information generated according to the single-page method is obtained are associated.

9. An image forming apparatus which inputs image information into another system that handles the image information, the image forming apparatus comprising:
an image information obtaining part configured to obtain plural items of image information that is generated as a result of plural sheets of paper of an original document being read;
an original identification information obtaining part configured to obtain, for each of the obtained plural items of image information, original identification information used for identifying each sheet of paper of the original document; and
an information output part configured to associate the obtained plural items of image information and the original identifying information obtained for each of the plural items of image information, and output it, wherein
the original identification information obtaining part is configured to use a number to identify each sheet of paper of the original document, and when the image information obtaining part obtains each of the plural items of the image information, the original identification information obtaining part is configured to obtain the number as the original identification information to be used for identifying each sheet of paper of the original document from which each of the plural items of the image information is obtained.

10. An image information input method of inputting image information into another system that handles the image information, the image information input method comprising:
temporarily storing, in a storage medium, plural items of image information that is generated as a result of plural sheets of paper of an original document being read;
temporarily storing, in the storage medium, a number to be used to identify each sheet of paper of the original document, and when storing each of the plural items of the image information, temporarily storing the number as the original identification information to be used for identifying each sheet of paper of the original document from which each of the plural items of the image information is obtained;
reading, from the storage medium, the plural items of image information and the original identifying information stored for each of the plural items of image information, associating the plural items of image information and the original identifying information stored for each of the plural items of image information, and outputting it; and
storing, in a storage apparatus, the output plural items of image information and the output original identification information associated with the plural items of image information.
